(19) United States
(12) Patent Application Publication
(10) Pub. No.: US 2010/0272915 A1
(43) Pub. Date: Oct. 28, 2010

(54) PORTABLE SPRAY BOOTH WITH AIR HANDLING SYSTEM

(76) Inventor: Seth Anthony Laws, Raleigh, NC (US)

Correspondence Address: PASSE' INTELLECTUAL PROPERTY, LLC, 1717 BRASSFIELD RD., RALEIGH, NC, 27614, US

(21) Appl. No.: 12/431,116

(22) Filed: Apr. 28, 2009

(51) Int. Cl. B05D 1/02; B05B 15/12

(52) U.S. Cl. 427/421.1; 454/52

(57) ABSTRACT

The present invention discloses a paint spray booth which consists of an inflatable structure. The structure comprises downdraft jets powered by the same air pressure that inflates the building. The downdraft air jets blow volatile paint fumes toward the bottom portion of the paint booth where one or more ventilation exhaust jets extract the volatile gases and filter the volatile gases out before ejecting clean air to the environment.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to an apparatus for containing an automobile for spray painting. In particular the present invention relates to a portable inflatable spray paint booth with a system for removing toxic fumes.

2. Description of Related Art

During the repainting of automobiles and other motorized vehicles it is frequently necessary to repaint all or part of the vehicle. Accidents, age and the like are frequent reasons for such repainting. In the past auto body shops with rooms designed to handle repainting of the automobile were the only course for repainting a car. Where a dealership had a car for resale this necessitated sending the car off site to the auto body shop and waiting a period of time for the auto to return. The cost in time and money has led to new businesses.

More recently the portable paint shop business has arisen. Auto body painters come to the dealer or other location with auto trailers, portable open buildings and the like, to paint the auto outside at the owner's location. The painting can be accomplished at a fraction of the cost and time of the old method. Accordingly, the onsite method of painting has become a widespread means for painting an automobile or other painted motorized vehicle.

Because the painting is done essentially outside during the on location painting process, the volatile fumes from the painting process would essentially escape into the atmosphere instead of the filtered air normally possible at an auto body shop. The United States government has passed regulations which prohibit the outside painting of an automobile without proper filtration and enclosure. Other countries are considering similar legislation.

Currently there are a wide variety of portable buildings available for use in the painting process that do not filter air or otherwise meet the new regulations. Frame structures, tarps, lightweight plastic edifices, and the like, have all been used. In general, these are structures that are open to the air and allow fumes and other toxic vapors to vent unchanged to the outside. One type of building has been used for a wide variety of uses including use as a painting booth. The inflatable building has been used for a number of years as a cheap portable or permanent structure for a wide variety of uses. In general the building is inflated with a motorized air pump and sealed. This is the process is much like filling a beach ball or an air mattress only larger. Air is added as the structure looses air.

Inflatable buildings for use as a paint booth have in general been open type structures to allow air to enter and leave the structure, in general, by flow of air from leaving a portion of the building open to the atmosphere. In one attempt to filter the air there has been a personal paint booth. In EP 1,319,442 published Jun. 18, 2003 there is disclosed a portable paint booth for placing a painter. A canopy extends from the booth and covers a portion of the car being painted allowing the car to essentially remain outside the booth. The painter remains inside the booth. Air is filtered by a single pump blowing air into the chamber (separate from the air used to inflate the device). The pump is positioned through an opening in the wall of the chamber that is not inflated. Air is removed by the same pump which draws air out of the device. The problem with the device is the pump recycles much of the volatile gases back into the cabin, the device is not capable of containing the entire vehicle and the pump only extracts air towards the bottom of the chamber in one location while most volatile gases will gather at the top of the chamber.

The device would not be suitable for use under the current US regulations for a completely enclosed painting area and would not filter air sufficiently to allow a person to remain in the cabin for long periods of time. An alternative method and device for a portable paint booth is necessary if this cottage industry is to survive the new regulations.

### BRIEF SUMMARY OF THE INVENTION

The present invention relates to the discovery that by creating a down draft in an inflatable building using the air flow that inflates the building, volatile paint fumes can be moved to the bottom of the inflatable building. After repositioning the volatile fumes the fumes can then be withdrawn from the building by one or more ventilation fans positioned towards the bottom portion of the building.

Accordingly, one embodiment of the present invention is a portable paint booth for painting a motorized vehicle by an individual with painting equipment for spraying paint having volatile paint fumes comprising:
a) an inflatable structure having an inside area large enough to enclose the vehicle and allow the individual to paint the vehicle inside the booth, the booth sealable to the outside during the painting process and having a resealable entrance for the vehicle, equipment and individual to enter the booth;
b) a motorized air pump for blowing air into the inflatable structure and inflate the structure;
c) a plurality of air jets in the ceiling of the inflatable structure positioned to create a downdraft within the structure for blowing volatile paint fumes toward the bottom portion of the paint booth, the air to the air jets received from air exiting the inflatable structure when the motorized air pump is operated; and
d) a motorized ventilation blower having one or more inlets positioned in a bottom portion of the booth connected to the blower via a duct such that volatile paint fumes blown to the bottom portion of the booth can be extracted through the inlet and then expelled by the blower exterior to the paint booth.

In another embodiment of the present invention there is disclosed a method of painting at least a portion of a motorized vehicle by an individual having spray paint equipment with paint having volatile fumes comprising:
a) positioning and sealing the vehicle and individual with the equipment and paint in an inflated inflatable structure having an inside area large enough to enclose the vehicle and allow the individual to paint the vehicle inside the booth, the booth having a resealable entrance for the vehicle, equipment and individual to enter the booth;
b) engaging a motorized air pump for continuously blowing air into the structure to inflate the structure;
c) engaging a plurality of air jets in the ceiling of the inflatable structure positioned to create a downdraft within the structure for blowing volatile paint fumes toward the bottom portion of the paint booth, the air jets receiving air exiting the inflatable structure when the motorized air pump is engaged;
d) engaging a motorized ventilation blower within the walls of the inflatable structure having one or more blower inlets positioned in a bottom portion of the walls of the booth connected to the blower via a duct, such that volatile paint fumes blown to the bottom portion of the booth by the air jets can be extracted through the inlet and then clean air expelled by the blower exterior to the paint booth; and
e) spray painting the vehicle.

### BRIEF DESCRIPTION OF THE DRAWINGS

FIG. 1 is a perspective view of the inflatable building of the present invention.

FIG. 2 is a cutaway view of the inside of the present invention building showing the operation of the downdraft blowers and the exhaust venting.

FIG. 3 is a cutaway end view of the present invention building to show movement of air from the blower vents to the exhaust vents which carry paint vapors out of the building.

FIG. 4 is a perspective of the inside of a paint booth as seen from the back wall.

FIG. 5 is a view of a ventilation blower with multiple inlets.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein “paint booth” refers to the interior of a building or structure that can be used to paint items in a safe manner considering the volatiles created during the painting process. The size of the paint booth is directly connected to the size of the item being painted and the equipment used to paint the item. A “portable paint booth” is a booth created by a structure capable of being transferred from location to location. The portable building is designed to be set up (inflated) at a particular location, used for a definite period of time and then unassembled (deflated) and transported to another location. The building is designed to be used to do spray painting work with volatile paints. Spray painting is done normally with compressed air and paint containers and is standard in the art of painting many items including a motor vehicle. Essentially, the portable paint booth can be set up at any location inside or outside and used as a spray painting booth. While the building could be left at a location for extended periods of time the design is such that it can be moved to different locations such as a plurality of auto dealerships, for paining vehicles at their location. The portable paint booths of the present invention are large enough to paint a motorized vehicle inside them.

A “motorized vehicle” refers to a vehicle such as a car, motorcycle, truck, RV or the like which after an accident has metallic or other surfaces which require repainting or where painted parts are replaced can be painted de novo. The painted area can be small or large on the vehicle depending on the individual motorized vehicle. Painting of such vehicles is done with “volatile paints”. The volatile substances are normally carrier solvents for holding the paint particles and which evaporate rapidly during the pointing process. Since these volatile compounds are dangerous and present a health hazard, in most cases they cannot be discharged into the atmosphere. The present invention, portable paint booth, becomes a solution to the paint a vehicle in place at multiple locations and still meet the new air quality and volatile substance laws and ordinances. In the practice of the invention, all or part of the paintable surfaces of the motorized vehicle could be painted when using the present invention.

“Inflatable structures” are by themselves well known in the art. They consist of a flexible plastic or other material wherein there are one or more air bladders which, when filled with air, cause the walls, ceiling and other parts of the material to inflate into the shape usable as a building. Air is supplied to an inflatable building normally by a motorized air pump since the size of a building is too large for a person to blow up a building by mouth as would be the case for a small ball or the like. Inflatable structures can be made in virtually any size as desired by the user of the building. For the purpose of the present invention the size of the building is such that the inside floor space is large enough to fit the entire desired motorized vehicle, the individual(s) who are painting the vehicle, the painting equipment and the volatile paint inside the portable booth. Inflatable structures can have non inflatable parts to them such as windows, liners, covers and the like. They can also comprise heaters, air conditioners, electrical connections, lighting and virtually anything normally used in a building or especially when compared to fixed or stationary painting booths.

The inflatable structure is designed to allow entrance of the vehicle, equipment and painters and then be sealed from the environment during the painting process. So there are walls, ceiling and a floor to the inflatable building as well as a resealable entranceway to the building. The floor could be attached to the inflatable part of the structure as could the door, but during use the attachment would require a seal from the environment. For example, the floor and doors could be zippered, velcroed (hook and loop fastened), snapped, chambered or any other way known in the art for sealing the interior of the inflatable structure from the environmental air. In one embodiment an air curtain is used as a sealable entrance and in another embodiment a plastic curtain is used. Other methods for obtaining a sealed inflatable structure would be obvious from the disclosure herein and the means for sealing the building is not intended to be a limiting means for the invention. An entrance could be a slit wall, a solid door or the like as desired for purposes of sealing the entrance and transporting the inflatable structure during use. In use the painter or someone else would move the vehicle into the booth, the painting equipment and paint would be brought in and then when the painter entered the booth the painter could seal the booth from the inside. In alternate embodiments a separate individual could seal the building from the outside.

In one additional embodiment, there are openings in the structure in addition to or part of the entrance door which would allow the user of the structure to back equipment (for example, in the back of a truck) up to the building opening and seal the opening around the equipment. In other words, the equipment would essentially stay outside the building with an access port in a structure, wall, door or the like, to the equipment sealed around the truck or the equipment. With this embodiment the structure does not need to be as large since all the equipment except the spray gun can remain outside the structure.

The inflatable structure could have optional accessories that are commonly found with inflatable structures. For example, plastic or other windows, electrical outlets, lights, air quality monitors and the like could also be included with the inflatable structure.

The portable booth will have a “motorized air pump’ to inflate the building. Motorized air pumps to inflate buildings are well known. The motorized air pump will be matched to the particular size of the building and the amount of air bladders needed to be filed and taking into consideration the downdraft air jets as explained elsewhere herein. Portability of the air pump would also be taken into consideration. One practicing the present invention would make efforts to minimize the number of people needed to set up the structure, taking the pump and other parts of the building into consideration. It is assumed during use of the building the inflatable structure will be set in place in a deflated condition. Next the air pump would be engaged and inflate the structure. The pump itself could be positioned at any convenient location inside the structure, inside the walls of the structure or outside the structure as desired.

In the present invention there is a “plurality of air jets” in the ceiling of the inflatable structure. The air jets are positioned in air connection with the air bladder in the ceiling of the inflatable building to create a down draft within the building. When the air jets are in an open condition (they can be openable or just fixed in an open position) the air from inside the building supplied by the air pump will exit the jets positioned in the roof. With sufficient positioning and number of jets in the roof of the inflatable structure a downdraft is created within the portable booth so long as the motorized air pump continues to blow air into the inflatable structure. One skilled in the art could determine without undue experimentation the position, size, number of the jets and any other parameters of the jets to create a downdraft based on the size of the building and the pressure of air within the inflatable structure sufficient to create a down draft condition.

The term “downdraft” as used herein refers to air blowing from the ceiling air jets downward inside the painting booth of sufficient air flow such that essentially any volatile paint fumes are blown toward the bottom portion of the booth. As long as the air entering the booth from the jets is clean breathable air, the user, i.e. the painter, will be breathing clean air. It is assumed that the volatile air will accumulate in perhaps the lower third or so of the booth but in any event such that the painter has fresh air to breath.

As the paint volatiles reach the lower portion of the booth interior there are a plurality of inlets positioned at or near the bottom of the inflatable structure walls. The inlets are ducted at least partially within the inflatable walls or along the floor of the booth area to a motorized ventilation blower which sucks air reaching the inlets through the ducting to an exhaust port after filtering the air sufficiently to remove the volatile contaminants. The exhaust port, which then has clean air exiting it, can be ported back to the environment or other location as desired. The ventilation blower itself could be positioned in the wall outside the building or at any convenient location for use as described. Motorized ventilation blowers are well known in the art such as the Allegro Axial ventilation blower with canister and ducting. Inlets in this ventilation blower could be positioned right into the duct work or secondary duct work connected to the main ductwork. This particular type of ventilation blower is AC explosion proof and thus, very suitable for use around volatile paints.

An embodiment of the method of painting at least a portion of a motorized vehicle would be as follows. After inflating and otherwise setting up the inflatable structure the entire vehicle would be positioned inside the booth. It should be clear then than even when only a portion of the vehicle is to be painted the entire vehicle is still moved entirely into the paint booth. The paint painting equipment is also moved into the inflatable structure or the equipment mated with an opening in the wall or door of the structure for use inside by booth while the equipment remains outside the booth. Once all the items are positioned inside the booth or at an opening as desired, the booth can be sealed. Any outside equipment has a seal around it. The main entrance is then closed, for example a curtain drawn, an air curtain turned on, a door zipped or otherwise sealed or the like. In one embodiment the door is made of clear Ising-glass by means known in the art, a flap created in the Ising glass wall and a zipper creating the final seal. When the inflatable structure is inflated, the paint booth, which is the interior of the structure is ready. It is possible to position the vehicle and set up the building and inflate it around the vehicle and paint/equipment and paint as well. However, at some point a motorized air pump inflates the inflatable structure. It should be noted, however, that the order of events as claimed in the method claims herein are not limited to the order as listed and could be reordered by one skilled in the art.

Once the motorized air pump is blowing air into the inflatable structure and the structure inflated the plurality or air jets, if not constantly open, could be opened. Closed air jets are an embodiment of the invention that allows a quicker inflation of the building since air does not leak out the jets during filling. Once the building is inflated and the air jets open, at this point a downdraft of air is created by air leaving the air jets in the ceiling of the inflatable structure. Since the down draft is not needed till painting begins the air jets could be left closed until painting begins and then opened. In this scenario the structure could be inflated, the air pump temporarily turned off while the car painter and equipment are placed in the booth. Then, just as painting is about to begin the air pump is re-engaged and the air jets are opened. In any event, the air jets are opened during the painting process as necessary to push volatile gases which tend to accumulate toward the upper portion of an enclosure down toward the bottom area of the booth.

Once the volatile gases reach the floor of booth the volatile gases can be filtered and removed by the motorized ventilation blower positioned with inlets in the walls of the booth area in the bottom portion close to the floor or merely laid on the floor along the wall or in a convenient location. That way as volatiles reach the inlet they are sucked into the inlet by the motor through the ductwork through an appropriate HEPA or other volatile fume filter before the cleaned air exits the structure back to the surrounding environment. Of course once the system of the present invention is turned on the vehicle spraying can begin. Once the spraying is finished the vehicle, person and equipment can be removed, the building deflated and moved to a new location.

The inflatable structure depending on the size and weight can be picked up by one or more people and transported by truck, trailer, RV or the like to the particular location used to paint a vehicle.

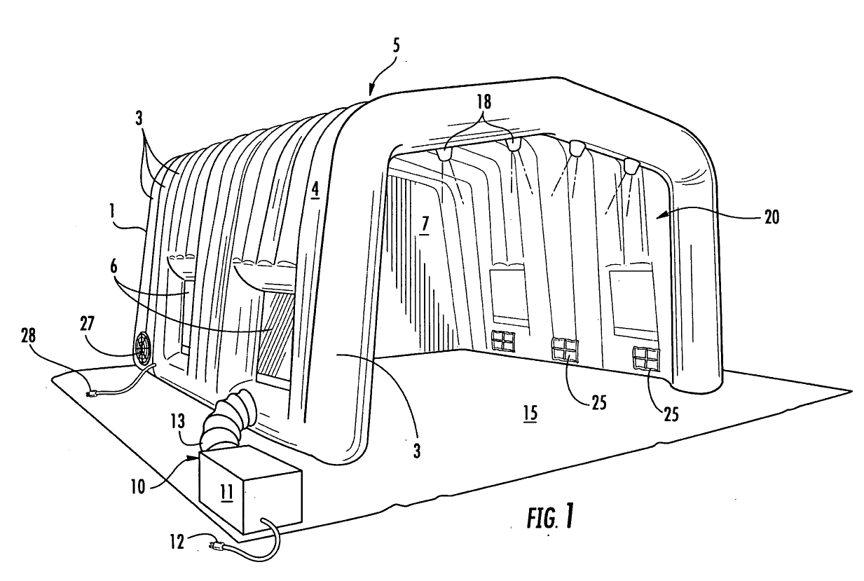

Now referring to the drawings, FIG. 1 is a perspective view of an embodiment of the present invention. The portable painting booth 1 of the present invention is shown already set up. The booth consists of inflatable tubes 3 which comprise the wall portion 4 and ceiling 5 of the booth 1. In this embodiment this particular structure also has window 6 for letting light into the paint booth painting area. In setting up booth 1, the user lays the entire uninflated booth 1 on the ground and turns on air blower 10 (in this view positioned outside the structure) consisting of blower unit 11, A/C plug 12 and air ducting 13. While the air blower 10 is shown as an alternating current (a/c) unit one could easily choose other power sources such as propane, battery or any other means for powering the blower unit 11 and blowing air into an inflatable building like paint booth 1. It is clear that a plurality of blowers 10 could be used in the practice of the present invention.

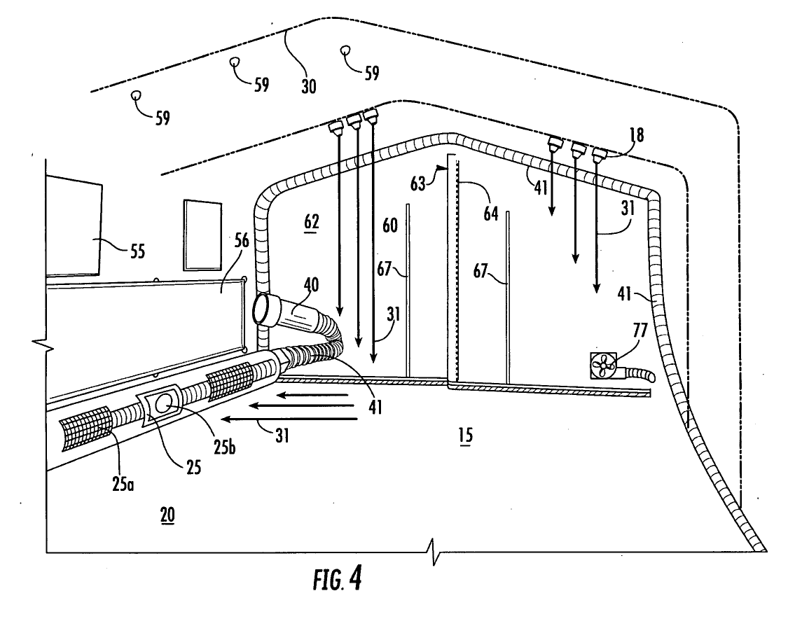

In the view depicted in FIG. 1 the floor 15 is shown as attached to the inflatable tubes 3 at the bottom of the booth 1. Certainly in other embodiments the floor could be detachably attached to the walls 4 and add the set of attaching the floor to the walls 4 during the initial set-up of the booth 1. For convenience in this view the door (depicted in FIG. 4) has been deleted for clarity but is a part of the present invention. In addition the wall opposite the opening 7 depicted would be another sealed wall. One skilled in the art would understand that from the disclosure herein. The back wall could be inflatable or another plastic not inflated wall.

Air from the air duct 13 enters the walls 4 of the inflatable tubes 3 of the paint booth 1. Once enough air has been blown into the tubes 3 the building stands erect and fully inflated. Once a vehicle, paint, sprayer and spraying equipment (or optionally otherwise positioned) are in the booth 1 and the door closed, sealing the booth 1 from the environment, the ceiling air vents 18 begin blowing air within the booth chamber 20 from the inner ceiling to the floor 15 creating a downdraft situation. In this view a row of four air vents 18 are depicted but vents could be in each of the ceiling tubes 3 or anywhere in the ceiling inner portion such that air from within the tubes 3 blows out the vents 18 essentially evenly within the interior 20 of the booth. Again while four vents are depicted any number sufficient to blow the air can be used consistent with creating a downdraft condition within the structure. The air once again comes from the blower into the tubes 3 and then out the vents 18. The vents can be openenable so that no air escapes unless desired or can be always open. One skilled in the art can manufacture or provide openable air vents and such is within the skill of the art. A closing feature will add to the rapidity of inflating the booth 1, however, and is one embodiment of the present invention. The exact flow from each vent will depend on the size of booth 1 and the distance the volatile gases have to travel from the top of the booth interior 20 to floor 15. One skilled in the art could, without undue experimentation, match air flow, vent numbers air blower strength and the like to achieve proper downdraft airflow. That flow needs to be sufficient to blow volatile paint fumes from the top area of the interior 20 where they would naturally accumulate and blow them to the floor area.

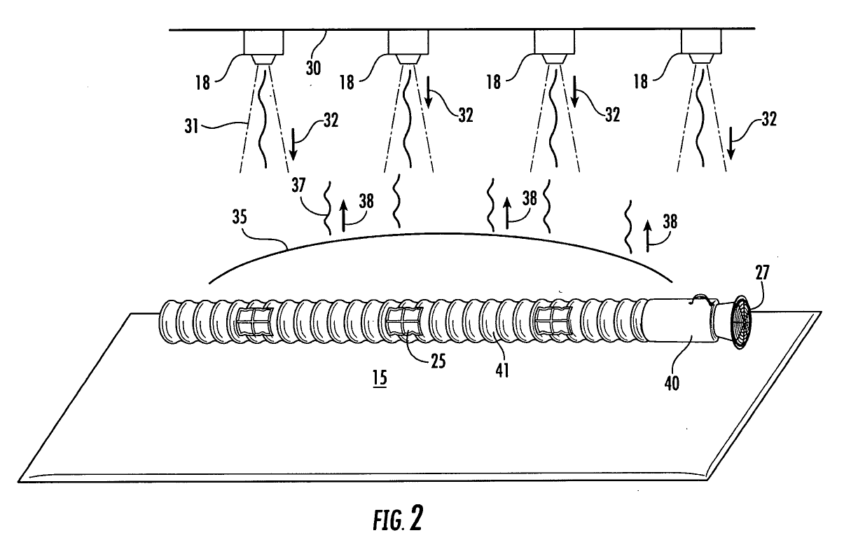

Once volatile gases reach the floor 15 exhaust vents 25 (depicted in this view as inside the walls of the structure) are capable of withdrawing the air around them and out to the environment. One or more ventilation blowers (depicted in FIG. 2) are connected to the exhaust vents 25 for filtration and exhaust exterior to booth 1 via exhaust port 27. Ventilation blower has an a/c plug 28 exterior to booth 1 for powering the booth. While A/C power is depicted, other means such as propane or battery or the like could be used to power the ventilation blower.

FIG. 2 depicts a cut-away view of an embodiment of the present invention for purposes of showing particular embodiments. The cut away view is a side view of the structure with the walls removed and only certain features depicted. In this embodiment four air jets 18 are depicted across the length of the booth mounted in ceiling 30. In this view air 31 is depicted as coming from air jets 18 and blowing downward 32. The walls have been removed in this view and the top of a vehicle 35 is depicted with the rest of the vehicle deleted for visual clarity. The top of the vehicle has been painted and paint fumes 37 from the painting process are moving upward 38. Lastly the ventilation blower 40 is shown with its ventilation exit port 27. The port would actually be positioned exterior to the booth area but is show as is for clarity. In this view the ventilation ductwork 41 is merely laying on the floor with exhaust vents 25 positioned across the floor 15 such that the downdraft air 31 will blow the paint fumes 37 to the exhaust vents 25 and thus drawn by ventilation blower 40 through the ductwork 41 and out exhaust port 27.

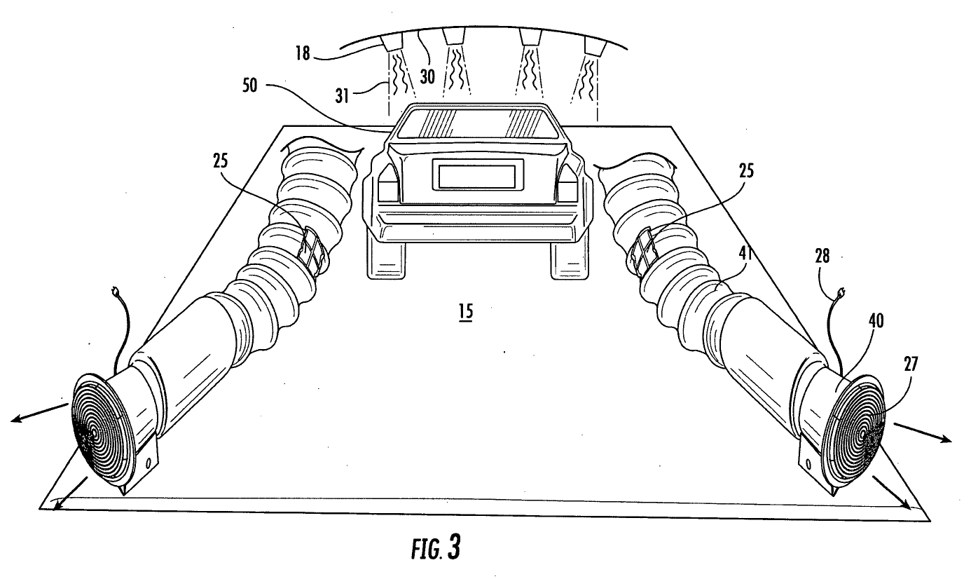

FIG. 3 is another cut-away view of an embodiment of the present invention. This view is from the entranceway of the booth but again with the walls removed. In this view one can see a vehicle 50 viewed from the rear in place inside the booth resting on the floor 15. This view shows four air jets 18 blowing air 31 downward as in FIG. 2 but it is depicted as traveling past the vehicle 50 and entering exhaust vents 25 on either side of the vehicle 50. Once again the ventilation duct 41 is shown lying on the floor 15 but could easily be positioned inside the walls of the booth.

FIG. 4 depicts a view from inside 20 of the booth from the perspective of someone inside the booth with their back up against the back wall facing the entrance 60. Several other embodiments are clear from this perspective. The ventilation ductwork 41 is shown to have a single ventilation blower 40. The ductwork 41 is shown in the wall of the building just above floor 15 and also continuing up around the opening 60 to the opposite wall and along the wall there as well. The exhaust vents are shown in more detail as having a removable filter 25a which when removed shows flange 25b for holding the filter 25a of vent 25. The entranceway 60 consists in this embodiment of clear Ising glass 62 having two separate pieces which over lap creating flap 63 which can be closed via zipper 64. Also depicted is Velcro flap edges 67 which can open during booth use and allow an painting equipment vehicle to back up to the opening and seal around the truck allowing the user of the booth to access equipment from the truck while still using the booth in a sealed condition. Other embodiments of the invention show are tear away covers 55 over windows 6 (hidden by covers). Also depicted is a removable liner 56 used for covering the inside of the walls and later being disposed to keep the interior surface of the booth clean. Also shown are optional lights 59.

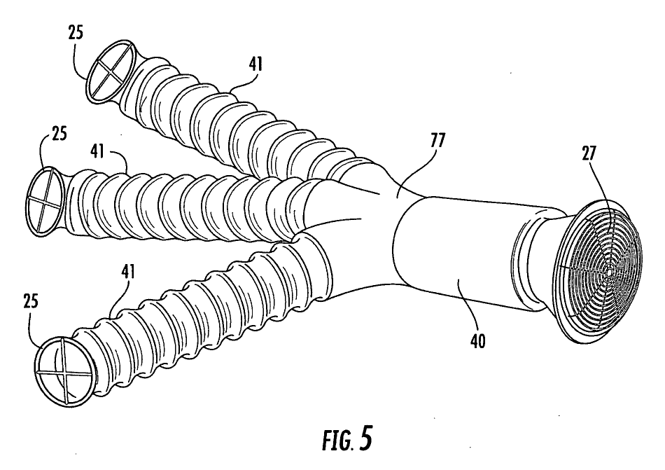

FIG. 5 shows an alternative arrangement for the ventilation blower 40. In this embodiment instead of exhaust vents 25 being positioned along duct 41 for delivery to exhaust 27 there is duct splitter 77 which splits the duct 41 into multiple ducts 41. By splitting duct 41 into multiple ducts in this manner the air suction from the ventilation blower 40 is more evenly distributed for suction along various locations in the booth. One skilled in the art could clearly determine other layouts for the ventilation blower in view of the disclosure herein.

In the practice of the present invention other embodiments of the invention for size and placement of items in the paint booth are possible as is clear from the description and teaching herein. None of the drawings or embodiments herein are intended to be limiting in the scope of the present invention and the claims which follow are to be so interpreted.

What is claimed is:

1. A portable paint booth for painting a motorized vehicle by an individual with painting equipment for spraying paint having volatile paint fumes comprising:
a) an inflatable structure having an inside area large enough to enclose the vehicle and allow the individual to paint the vehicle inside the booth, the booth sealable to the outside during the painting process and having a resealable entrance for the vehicle, equipment and individual to enter the booth;
b) a motorized air pump for blowing air into the inflatable structure to inflate the structure;
c) a plurality of air jets in the ceiling of the inflatable structure positioned to create a downdraft within the structure for blowing volatile paint fumes toward the bottom portion of the paint booth, the air to the air jets received from air exiting the inflatable structure when the motorized air pump is operated; and
d) a motorized ventilation blower having one or more inlets positioned in a bottom portion of the booth connected to the blower via a duct such that volatile paint fumes blown to the bottom portion of the booth can be extracted through the inlet and then expelled by the blower exterior to the paint booth.

2. A paint booth according to claim 1 wherein the resealable door is a plastic curtain.

3. A paint booth according to claim 1 wherein the resealable door is an air curtain.

4. A paint booth according to claim 1 wherein there are a plurality of ventilation blowers.

5. A paint booth according to claim 1 wherein the ventilation blower has a plurality of inlets connected to the duct.

6. A paint booth according to claim 1 wherein the duct from the ventilation blower is positioned inside the wall of the booth.

7. A paint booth according to claim 1 wherein the duct from the ventilation blower is positioned on the floor of the booth.

8. A paint booth according to claim 1 wherein there is an additional opening in the booth for positioning spray equipment or an equipment vehicle outside the booth such that the booth has access to the equipment or vehicle during booth use.

9. A paint booth according to claim 1 wherein the paint booth has a removable floor.

10. A method of painting at least a portion of a motorized vehicle by an individual having spray paint equipment with paint having volatile fumes comprising:
a) positioning and sealing the vehicle and individual with equipment and paint in an inflated inflatable structure having an inside area large enough to enclose the vehicle and allow the individual to paint the vehicle inside the booth, the booth having a resealable entrance for the vehicle, equipment and individual to enter the booth;
b) engaging a motorized air pump for continuously blowing air into the structure to inflate the structure;
c) engaging a plurality of air jets in the ceiling of the inflatable structure positioned to create a downdraft within the structure for blowing volatile paint fumes toward the bottom portion of the paint booth, the air jets receiving air exiting the inflatable structure when the motorized air pump is engaged;
d) engaging a motorized ventilation blower within the walls of the inflatable structure having one or more blower inlet positioned in a bottom portion of the walls of the booth connected to the blower via a duct such volatile paint fumes blown to the bottom portion of the booth by the air jets can be extracted through the inlet and then clean air expelled by the blower exterior to the paint booth; and
e) spray painting the vehicle.

11. A method according to claim 10 wherein there are a plurality of ventilation blowers.

12. A method according to claim 10 where the equipment positioned inside the booth is a spray canister and the remaining equipment used to paint the vehicle is positioned outside the booth in a manner such that it is accessible from inside the booth without leaking fumes to the outside.

13. A method according to claim 10 wherein the air jets are opened after the building is sealed.

14. A method according to claim 10 wherein the inflatable structure is set up outdoors.
